(19) United States
(12) Patent Application Publication
(10) Pub. No.: US 2011/0072133 A1
(43) Pub. Date: Mar. 24, 2011

(54) SYSTEMS AND METHODS FOR MONITORING AND CONTROLLING COMMUNICATION TRAFFIC

(76) Inventors: Michael Sullivan, Herndon, VA (US); Alan T. Sullivan, Leesburg, VA (US)

(21) Appl. No.: 12/954,383

(22) Filed: Nov. 24, 2010

Related U.S. Application Data
(63) Continuation of application No. 11/224,681, filed on Sep. 13, 2005, now abandoned.
Application No. 11/224,681 is a continuation-in-part of application No. 11/019,369, filed on Dec. 23, 2004, now abandoned.

(51) Int. Cl. G06F 15/173

(52) U.S. Cl. 709/224

(57) ABSTRACT

Communication traffic monitoring and controlling systems and methods are disclosed that allow for controlling communication traffic over the Internet based on the identity of particular users using potentially volatile information, such as a dynamically assigned IP Addresses. The system and method allow a controller to personalize services for users without the need for the user to supply personal information, such as name, address, and the like, and without the need to have computer programs or code installed on the user's computer. Methods of doing business with a computer are provided based on the systems and methods of communication traffic monitoring and controlling.

### CROSS-REFERENCE TO RELATED APPLICATIONS

This application is a continuation application of U.S. patent application Ser. No. 11/224,681, filed 13 Sep. 2005, which is a continuation-in-part application of U.S. patent application Ser. No. 11/019,369, filed 23 Dec. 2004. The application relies upon the filing date of the prior applications, and those applications are hereby incorporated herein in their entireties by reference.

### BACKGROUND OF THE INVENTION

1. Field of the Invention

The present invention relates generally to monitoring and controlling movement of information within a communications network. More specifically, the present invention relates to systems and methods for monitoring communications between specific users of computer networks or the Internet and their Internet Service Provider (ISP), and providing communication services to those users. The systems and methods rely, in part, on the ability to identify particular users of a communication network based on stable and ephemeral information. Further, the systems and methods can provide communication services, such as content-relevant information, to the users based on a database of information relevant to each user.

2. Background of the Invention

One power of the Internet is the ability to connect two computers in geographically distant areas. Often, a computer user knows the precise IP Address of a computer with which he would like to connect. In such a situation, the user will submit the IP Address to the Internet infrastructure, and be connected directly to the desired computer.

Typically however, computer users do not know the actual IP Address of the computer they wish to contact. Rather, they know the name, in a human language, of the web page or e-mail address they wish to contact. In such a situation, they cannot connect directly to the computer of interest, but must rely on the network or Internet infrastructure to provide them the correct IP Address and make a connection to the target computer using a search and connect strategy. In general under such circumstances, information is transmitted through computer systems, such as networks and the Internet, from one user to another by way of a series of designated transfer point computers referred to as servers. The key server type in transmittal of information through networks is the domain name server, or DNS (used as an abbreviation for both the singular and plural). There are two main types of DNS: authoritative DNS and caching/recursive DNS. Authoritative DNS are servers that contain a mapping of host names (typically human recognizable character strings) and Internet Protocol (IP) Addresses within their own particular domains. They supply a specific IP Address of a computer in their domain upon request from another computer (its client) in order to enable one computer to contact another. In contrast, caching/recursive DNS are servers that do not initially know IP Addresses of a specific users' computers. Rather, caching/recursive DNS know how to find Authoritative DNS servers that have the name to IP Address mapping data. When a caching/recursive DNS receives a request for an IP Address from a client, it contacts Authoritative DNS servers to identify the specific Authoritative DNS that knows the particular IP Address of interest to its client. Upon identifying proper authoritative DNS, the caching/recursive DNS contacts one or more of those, and obtains the IP Address of interest. The caching/recursive DNS then returns the IP Address to its client so that a connection between the client and the computer at that IP Address can be made.

In a common scenario, the user types into the Internet browser resident on his personal computer a particular web site of interest in the form of a Uniform Resource Locator (URL; e.g., http colon double slash www dot paxfire dot com). The browser on the user's computer sends a request to a caching/recursive DNS (typically a DNS owned and/or operated by his ISP) to convert the host/domain name to an IP Address for it. The caching/recursive DNS, if it knows this information from a previous lookup (hence the term “caching” is used), will supply it to the user's browser, and a connection between the two computers is made. If it does not know this information, it makes a request to an Authoritative DNS to begin the process of querying authoritative servers for the IP Address information. Typically, the first Authoritative DNS queried is at the root level (also referred to as a “root DNS”) to begin the process of locating the Authoritative DNS server for the requested hostname/domain name. The root DNS servers contain a list (mapping) of which top-level domains exist, and the IP Addresses of the Authoritative DNS servers for each domain (example: .com). Once the caching/recursive server knows the IP Address of the top-level domain server, it contacts it directly to query about the hostname/domain name that it is looking for. The top-level domain server will respond to the query with a pointer to the second-level DNS servers that are authoritative for that domain, if it exists. The caching/recursive DNS then queries the second-level DNS server that is authoritative for that domain for the IP Address of the hostname/domain name it is looking for, and if it exists, the server will respond with one or more valid IP Addresses to the request. If at any time an Authoritative server in the resolution path determines that the requested hostname/domain name does not exist, that Authoritative DNS informs the caching/recursive DNS that the requested information does not exist, and this result is typically passed back to the user's browser. If the requested IP Address exists for the hostname/domain name, the caching DNS then passes the IP Address down to the user's browser, and a connection is made between the two computers.

While the particular details of telephony, Instant Messaging (IM), Voice Over IP (VoIP), and other technologies that rely on the Internet to traffic information might differ in certain aspects, the same general “up-and-down” communication among servers within the Internet infrastructure is used to identify telephone numbers, usernames, addresses, etc. and to make connections between a requestor and a target or to deliver error messages when a failed look-up occurs.

Control of traffic is an important aspect of communication, whether it be Internet communication, telephone communication, or any other type of communication that relies on computers. Efficiency, reliability, and accuracy are key considerations when users select communication service providers. Furthermore, control of communication traffic particularly over the Internet, can be a source of income. For example, Internet searches can be monetized by providers of search engines by selling advertising space on landing pages provided to users in response to searches or DNS queries. Various methods and systems for controlling Internet traffic are known in the art, including those taught in U.S. Pat. No. 6,631,402, U.S. Pat. No. 6,608,893, U.S. Pat. No. 6,601,208, U.S. Pat. No. 6,205,477, U.S. Pat. No. 5,987,611, U.S. Pat. No. 5,933,490, U.S. published patent application number 2005/0027882, U.S. published patent application number 2005/0105513, and U.S. published patent application number 2004/0042447 A1.

Likewise, methods of marketing and communication traffic selling are known. For example, such methods are taught in U.S. Pat. No. 6,631,402, U.S. published patent application number 2004/0044622, U.S. published patent application number 2004/0044791, and U.S. published patent application number 2004/0044566.

U.S. published patent application number 2005/0105513 discloses an Internet appliance that is capable of redirecting Internet traffic and supplying content-relevant information in response to various queries. The appliance can be installed at the ISP level of the Internet architecture, and can eliminate the need for cookies or other computer-resident programs for tracking information about a particular user so that content-relevant information can be provided to that user.

Although the systems and methods currently used in commerce for controlling communication traffic provide numerous advantages, one key drawback of those methods is that they lack the ability to identify and track particular users and their behavior without asking for personal information during each interactive session, or installing computer code on the user's machine (e.g., cookies, spyware). Without such requests or machine-resident programs, the systems and methods available in the art can merely track users based on IP Addresses, which, as discussed above, can change from one user session to the next. Users of computer systems are now keenly aware of the dangers of permitting others to write code to their hard drive or maintain personal information about them on computers outside of the direct control of the user. Indeed, many, if not most, computer users now refuse to allow personal information to be stored on another's computer (or deny access to their hard drive by others) unless there is some assurance of confidentiality regarding the information.

Thus, there exists a need in the art for systems and methods for controlling communication traffic and providing content-relevant search results that also provides a secure, confidential way to track the behavior or preferences of individual users or networks, yet is not burdensome on the user and does not require additional, potentially confidential information to be stored on the user's computer or transmitted through the Internet.

### SUMMARY OF THE INVENTION

The present invention provides systems and methods that monitor communications between users and their ISP, and control communication traffic, such as that over a network, the Internet, and through telephones. Unlike systems and methods currently in use, the present systems and methods monitor networks and individual users not only during a single communication session, but over multiple sessions. Such monitoring is enabled by identifying and tracking users based on non-volatile information regarding the particular computer in use, such as the MAC address or circuit ID of the computer. Information regarding the user, his preferences for searching and delivery of search results, his history of searching, and other information can be maintained in the system and can be used to control current or future communications from and to the user. The systems and methods can be implemented at any point in the communication pathway, but are preferably implemented at one or more points at which non-volatile information about the identity of the user is transmitted, such as at the ISP level. The systems and methods can be used for any suitable purpose, including, but not limited to, providing Internet access and search services that are customized to the preferences of the user, providing content-relevant search results or advertising, optimizing the speed and results of search sessions, and providing information of interest to the user automatically upon log in or in response to pre-set queries.

Integrated systems implementing the methods of the invention are referred to herein at points as an Internet appliance, and unless otherwise specified such a term should be interpreted as referring to the systems, methods, or both, of the invention. The term Internet appliance should not be understood to be limited to uses over the Internet, per se, but should be understood to include all communications over communication systems, including, but not limited to, telephony.

Furthermore, the terms “user”, “computer”, and “subscriber” are used to identify three general tiers or levels of interaction within the systems of the invention. As used herein, a user is a particular person using a communication device, such as a computer or telephone. A computer according to the invention is any device that can be used by a user to communicate over a network. For example, a computer can be a personal computer, which may serve multiple users within one office or home. Likewise, a computer may be a telephone, which also may serve multiple users within one office or home. As used herein, a subscriber is a communication device that interacts with and/or controls traffic within one or more communications networks. For example, a subscriber may be a router that connects one or more computers to a network, such as one managed by an ISP.

In one aspect, the invention provides an Internet appliance for monitoring communication traffic. Monitoring of communication traffic can occur in any network, including but not limited to, a computer network (e.g., the Internet) and a telephone network. For ease of description, the present invention is described predominantly with regard to computer networks, and in particular with regard to the Internet. However, it is to be understood that each reference to a particular computer system for use in Internet communications can have a corresponding system in other communication areas, including, but not necessarily limited to telephony. Thus, references to Internet systems are to be understood to be expansive, and to include the corresponding systems, devices, communication routes, etc. of other communication areas.

At its basic level, the Internet appliance provides an automated system and method for monitoring communication traffic between a user and his ISP, and particularly between these two during the process of assignment of a device identifier, such as an IP Address, to a particular computer by the ISP. By monitoring this communication, the Internet appliance of the invention can determine the true identity of the user (at least to the level of the subscriber), and provide services that are specifically tailored to that user. This monitoring function provides an advantage not supplied by other methods of communication monitoring or control because it combines the use of ephemeral and “static” data elements to identify a particular computer or service subscriber. The Internet appliance can also monitor communication traffic between a particular user or network and others, and does not require the user to manually supply any information about himself or his network. Furthermore, the Internet appliance for monitoring communication traffic does not require any information or computer code to be placed on the user's computer, either permanently or temporarily. However, in embodiments, some tracking information (e.g., cookies) can be placed on the user's computer to provide certain benefits, such as the ability to provide services to individual users who share a computer (e.g., personal computer, telephone) for communications purposes.

Among the many advantages provided by the present invention through its various embodiments, one includes the solution to a problem recognized in the field. More specifically, the present invention, by monitoring assignment of identifiers in any network in which it is implemented, avoids the cumbersome and often annoying need for a user to log-in or otherwise personally identify himself in order to access information or make a desired communication connection. For example, the present invention relieves the requirement for Internet users to log in to each site of interest to them. Rather, the systems of the invention either transmit that information to the relevant site or transmit another identifier that it can then correlate to the actual user.

Unlike other systems for monitoring assignment of device identifiers, such as IP Addresses, to subscribers to a network, the systems of the present invention use dynamic packet inspection of communications between users/computers/subscribers and the device identifier assignment server. For ease of reference, the device identifier server will often be referred to simply as an IP Address assignment server from here on. While the term IP Address assignment is more limited in scope than the term device identifier assignment server, it is used as an example of a type of device identifier assignment server, and its use is intended not only to teach that particular type of device, but to teach concepts that can be applied with other device identifiers. Through this dynamic process, the systems and methods of the present invention can determine when an IP Address is bound to a unique identifier that identifies the particular user/computer/subscriber. The systems and methods of the invention are in contrast to other systems and methods used by ISP, which statically store such correlative information, and use it only in circumstances when a request for the information retrieval is submitted to the ISP. That is, other systems correlate this type of information, but do not use it proactively in a communication session to control traffic. Rather, the information is collected and stored for use if, and only if, a request is made for the information in response to a particular set of conditions.

In another aspect, the invention provides an Internet appliance for controlling and/or influencing communication traffic. The Internet appliance provides an automated system and method for controlling communication traffic from or to a particular user or network, and does not require the user to manually supply any information about himself or his network. Because the Internet appliance can identify a particular user by his MAC Address or circuit ID rather than merely by IP Address, it can maintain a database of user preferences and history that is specific for each particular computer or subscriber attached to the ISP. The same holds true for addressing systems in other communications networks, such as e.164 for telephony. Furthermore, the Internet appliance for controlling communication traffic does not require any information or computer code to be placed on the user's computer, either permanently or temporarily, although in some embodiments, such code is used to provide certain additional services.

In yet another aspect, the invention provides an Internet appliance for conducting business over a communications system. Accordingly, the invention provides a method of conducting business using computers. The systems and methods include maintaining a database of information relating to a particular subscriber, computer, user or network based on the ephemeral IP Address, which it can correlate to a unique identifier for the computer or subscriber (such as the MAC address), and consulting that database for information that might be relevant to that computer or subscriber or network for a particular communication. For example, the database can be consulted to identify whether a particular computer or subscriber has joined a service plan for Internet services, whether the user/subscriber prefers to avoid certain web sites when search results are returned (e.g., prefers not to receive adult web sites in response to queries), to identify prior search terms relied upon by a user, or to provide a list of web sites commonly visited by a particular user. According to the present invention, consulting a database can be through processes of interrupting or polling. That is, consulting a database can be by way of servers constantly checking with the database for any update (i.e., polling) or by way of the system of the invention actively sending messages to servers of interest, indicating that new information is available to those servers (i.e., interrupt).

### BRIEF DESCRIPTION OF THE DRAWINGS

FIG. 1 is a block diagram showing one embodiment of the Internet appliance of the invention, in which the appliance is integrated within the communication system between the IP Address assignment server and the user/subscriber.

FIG. 2 is a block diagram showing one embodiment of the Internet appliance of the invention, in which the appliance is connected to the communication system as a non-integral tap at a point between the IP Address assignment server and the user.

FIG. 3 is a block diagram showing one embodiment of the Internet appliance of the invention, in which at least a portion of the appliance is integrated within the communication system as part of the IP Address assignment server.

FIG. 4 is a block diagram showing information flow within certain embodiments of the systems of the invention.

FIG. 5 is a block diagram showing information flow within certain additional embodiments of the system of the invention.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed description describes certain embodiments of the invention, and should not be considered as limiting the invention to those embodiments.

The Internet provides a user a quick and accurate direction to a particular web site or web page if the user knows the exact web site or web page address, either through its IP Address or through its host name/domain name. However, as an increasing number of people have become comfortable with use of the Internet and have begun to understand the power of the Internet to provide information and services, the number of users knowing the actual IP Address of a site of interest has plummeted. Indeed, currently, the vast majority of Internet communication other than e-mail is by way of a search, at least initially, for web sites that might provide relevant information relating to a user's query. Upon receipt of the search results, the user can then select one or more web sites that appear to contain the precise information of interest. However, due to the imprecise nature of results provided in response to a query, often users are presented with irrelevant or otherwise unwanted search results. Such results diminish the efficiency and effectiveness of Internet searching, and reduce the effectiveness of the Internet as a means for providing information. Furthermore, poorly targeted results are a drain on the resources of advertisers and others who supply information based on search results.

In view of this evolving model of Internet use, it is apparent that systems for monitoring and controlling communication traffic are necessary to optimize efficiency, effectiveness, and accuracy of searching for and receiving information. Furthermore, in view of this evolving model, methods of capturing traffic and providing content-relevant information (e.g., advertising), particularly based on user preferences, can provide revenue to various service providers within the communication system, as well as provide the information providers (e.g., advertisers) an opportunity to reap profits from customers. The present invention provides a system and method for monitoring communication traffic that enables users to efficiently obtain personalized information from a communications system, such as the Internet. The present invention also provides a system and method for controlling communication traffic that provides those same benefits as well as provides information providers the ability to have their information targeted more accurately to a market segment. Furthermore, the present invention provides a method of doing business using computers that utilizes the identity of specific subscribers to identify a user and to deliver content-relevant information of commercial value to the subscriber.

The present invention offers a solution to problems associated with communication monitoring and trafficking, and doing business through computers and the Internet. The solution is an Internet appliance for monitoring and/or controlling communication traffic, and for providing information, including information useful for conducting business, to users based on personal preferences, current queries, and personal and historical information obtained from prior communications. The systems and methods according to the present invention are suitable for use in any computer-driven communications system, such as Internet systems and telephony. In preferred embodiments, it is implemented at the ISP level of the Internet architecture, and particularly at the ISP DHCP or RADIUS server or a point between these servers and the user. By installing the Internet appliance at this juncture in the Internet architecture, the invention provides a way to identify particular users or subscribers of the Internet by non-volatile means, such as by their MAC Address or circuit ID. This is a significant departure from currently used technologies, which are limited to the browser or application level and rely on obtaining personal information on each user by monitoring that user's activities or by asking for personal information directly from the user. By implementing the Internet appliance of the invention at the ISP level, the invention permits a plethora of information that is, in sum, specific for each user (or, more accurately, each computer linked to the communication chain) to be collected and maintained, and which can be used to deliver highly relevant content to the requestor. Yet, at the same time, the present invention avoids use and burdening of individual personal computers to store information relevant to the numerous different types of searches possibly enacted by each user, and can be configured to avoid collection of confidential information or information that the user would otherwise prefer not to divulge (e.g., name, Social Security Number, credit card number(s), age, sex). In embodiments, it also protects the requestor's personal information from being stored on an easily accessible system (like the user's PC) because this information is stored in the infrastructure systems of an ISP. Furthermore, in embodiments, the Internet appliance of the invention can provide very high security to the user by monitoring and blocking access to undesirable Internet locations, such as those involved in criminal activities.

The Internet appliance according to the present invention provides a more robust experience for the Internet user while allowing the user's local computer to conduct other tasks. Resources of users' personal computers are freed (as compared to systems and methods relying on browser or application level implementation of other systems) and not required to participate in direction of the browser to a landing page. Furthermore, because in preferred embodiments the present systems and methods would reside, at least partially, in the network of ISP near the ISP DHCP or RADIUS server(s), information about the user's location will be available to the Internet appliance, and that information can be blended with other information to provide a geographic- and content-relevant redirect landing page in response to user queries.

The invention as described herein provides a way to present to users a customized Internet search experience that takes into consideration pre-defined preferences provided by the user. Thus, it eliminates unwanted search results for users, based not on globally-defined criteria, but on criteria defined by each particular user. In addition, because it is implemented at the ISP level of the Internet architecture, it can eliminate the need to redirect various types of queries at the browser or application level, thus freeing up resources on the user's computer. Of the many advantages provided by this shift to the ISP level, a key advantage is to eliminate the need for users to manually identify themselves to obtain ISP based services in order to have pre-defined preferences for communications implemented.

The invention thus provides the ability to personalize a user's experience in communication over communications networks, such as the Internet and telephones. To do so in, for example, Internet communication, the invention associates a particular IP Address with a particular computer or subscriber to a service. Doing so avoids a current problem with other monitoring and controlling systems, which is the problem that an IP Address can change from one communication session to the next. That is, ISP typically assign IP Addresses to subscribers as they begin a communication session, on a rolling basis—an available IP Address is assigned to the subscriber upon log on, and this IP Address is returned to the pool of available IP Addresses controlled by the ISP upon log off. The present invention, by monitoring the assignment of IP Addresses by the ISP through its DHCP or RADIUS servers, upon log on of each subscriber, can identify a particular subscriber/computer using their IP Address.

In a first aspect, the invention provides a system and method for monitoring communication traffic. The system and method are implemented by way of an Internet appliance that sits at the ISP level of the Internet architecture and monitors communication between users and their ISP. Monitoring is conducted at least during the period of time at which the DHCP or RADIUS server of the ISP is confirming the identity of the user and assigning it an IP Address. During the log on process, a user's computer contacts the ISP, and requests that an Internet connection be made and an IP address be assigned. In response, the ISP, though its DHCP or RADIUS server, confirms the identity of the computer (e.g., by inspecting its MAC Address, circuit ID, or digital certificate), then assigns it an IP Address. The IP Address may be assigned for that session only (e.g., in a network that uses dynamic assignment of IP Addresses) or for all subsequent sessions (e.g., in a network that uses static IP Address assignments). All communications between the particular computer and others in the Internet from that point forward are based on the IP Address that has been assigned. By monitoring the communications between the subscriber and the ISP during the IP Address assignment period, the Internet appliance of the present invention can identify the subscriber computer by use of even dynamically assigned IP Addresses, and can provide individualized services to the user that are based on information maintained in one or more databases of information provided by the user (either manually in response to questions or prompts from programs, or automatically, such as by way of prior communication patterns).

As mentioned above, monitoring occurs at the time of initial communication between the user's computer and the ISP. In embodiments, monitoring can continue throughout the communication session at different points in the ISP network. It can also occur at two or more short, discrete intervals, one at log on and one or more at a later time during the communication session.

Upon learning of the identity of the computer logging on to the ISP, the Internet appliance of the invention can consult its database or table of information to determine one or more pieces of information about the particular user. For example, the Internet appliance can determine if the computer is a subscriber to a particular service, such as a service provided by the owner and/or operator of the Internet appliance. After consultation of the database, the Internet appliance of the invention can then provide services that are tailored to the particular computer in use at a particular IP Address, during the initial communication session and subsequent sessions.

For example, the systems of the invention can provide a web page that permits a user, computer, or subscriber to opt-in or opt-out of services. When a user goes to a landing page containing opt-in/opt-out information, and if that user decides to opt-out of all services available from the ISP through various systems, the web server hosting the web page contacts the Internet appliance containing a database correlating one or more unique identifiers for the user and his IP Address. The web server will inform the Internet appliance that is should monitor all communications from the user bound to that IP Address (e.g., note which MAC Address/Circuit ID has that IP Address, so that it can now track activity of that MAC Address/Circuit ID). The Internet appliance will then notify relevant servers of the ISP that the particular IP Address for that user has opted-out of service(s). From that point on, the Internet appliance monitors the IP Address assignment server to determine if any changes to the IP Address have been made. When a change is made, the Internet appliance updates the information with the relevant servers of the ISP to ensure that the user's preferences are maintained. Of course, the same type of monitoring can be accomplished for situations where a user has elected to receive all services or any subset of services offered by the ISP. Upon completion of a communication session and the commencement of a new session, the Internet appliance can identify the new IP Address that is bound to the particular unique identifier(s) for the user/computer/subscriber, consult its database to determine the services to provide to that particular user/computer/subscriber, and inform the relevant servers of the ISP of the services to provide to the IP Address. In this system, at least one server of the ISP is capable of, and is tasked with the job of, looking for IP Addresses associated with communications, and directing the communications to suitable servers (in the case where services are expected by the user), or passing the communications on to their intended destinations without modifying the communication (in the case where services are not expected by the user).

Numerous Internet appliances may be used to implement the systems and methods of the present invention. However, because of the advantages of the Internet appliances disclosed in U.S. published patent application 2005/0027882 and U.S. published patent application 2005/0105513, those Internet appliances are preferred. Both of these patent applications are incorporated herein in their entireties by reference. The overriding concept of the invention is the monitoring of assignment of IP Addresses to particular computers, and use of the correlation of the IP Address to a particular computer to provide services, such as business services or information searching services.

At its basic level, the Internet appliance provides an automated system and method for monitoring communication traffic between a user and his ISP, and particularly between these two during the process of assignment of an IP Address to a particular computer by the ISP. By monitoring this communication, the Internet appliance of the invention can determine the true identity of the user (at least to the level of the subscriber's network device connected to the ISP's service), and provide services that are specifically tailored to that user. This monitoring function provides an advantage not supplied by other methods of communication monitoring or control because of its ability to identify a user based on the assignment of an ephemeral IP address. The monitoring function is automatic, requiring no manual input of information from the user or ISP. Indeed, the monitoring is performed without the knowledge of the user, and without any significant or apparent effect on the communications between the user and ISP during log on. Because the Internet appliance is simply monitoring communications between the ISP and the user in the network, it does not require any programs or code to be resident on the user's computer.

One advantage that the Internet appliance can provide is a personalized communication session for users. For example, the Internet appliance can provide search services that are tailored to individual user's particular likes and dislikes. In one embodiment, the Internet appliance provides a subscriber platform in which each subscriber of a particular ISP is given the opportunity to participate in a personalized communications program, which provides personalized communication services to the user. If the user chooses to participate in the program (“opts in”), then a series of questions can be posed to the user. Responses to those questions can be maintained in a database, and future communication sessions can be controlled based on the information in the database. For example, users can be asked whether any subject matter is inappropriate as responses to Internet searches. Users who respond that adult web sites, for example, are inappropriate will have all future search results screened prior to delivery to the user, and all adult web sites removed from the search results prior to delivery. Alternatively, if a user chooses not to participate in the program (“opts out”), then all future communications from that particular user will be passed through the Internet appliance without monitoring or alteration in any way. Other exemplary advantages are disclosed in U.S. published patent applications 2005/0027882 and 2005/0105513.

As discussed above, the Internet appliance can monitor communication traffic between a particular user or network and others, and does not require the user to manually supply any information about himself or his network. Thus, a database of information about particular users can be developed and maintained, and services personalized to that user can be provided. For example, search terms commonly used, and preferred sites visited based on those terms can be used to determine content-relevant results (e.g., advertising) to be displayed in response to future searches.

An advantage of the present invention is the avoidance of maintenance of any information or computer code on the user's computer or by the ISP, either permanently or temporarily, in order to implement the systems and methods of the invention. Monitoring of assignment of IP Addresses during the log on process eliminates the need to place or maintain any information on any user's computer because all of the necessary information about that computer is being transmitted to the ISP at the time of log on. Furthermore, because monitoring can be continuous or reinstated at discrete times during the communication session, if the ISP alters the IP Address during the communication session, the Internet appliance of the invention is capable of following that reassignment and continuing to properly identify the subscriber.

Accordingly, the present invention provides a method of monitoring communication traffic between a DHCP or RADIUS server and a particular computer. The method comprises receiving information from the user about its identity, receiving information from a computer responsible for assigning an IP Address to the user's computer, and correlating the identity of the user's computer to the IP Address. In embodiments, the information about the user's computer's identity is received directly from the user's computer. In other embodiments, the information is received from the DHCP or RADIUS server, either directly or through one or more other computers. The information about the user's computer's identity can be any non-volatile information, such as its MAC Address, its circuit ID, and/or its digital certificate. In embodiments, the identity of the user's computer and the corresponding IP Address are maintained for a period of time, such as throughout a single communication session or throughout two or more communication sessions. In embodiments, the method comprises continuously monitoring communications between the user and the computer that assigns an IP Address to determine if the same IP Address is used in subsequent communication sessions. In embodiments where the IP Address is altered during the communication session, the method can comprise updating the information regarding the correlation of IP Address to computer identity.

In another aspect, the invention provides an Internet appliance and method for controlling communication traffic. The Internet appliance provides an automated system and method for controlling communication traffic from or to a particular user, subscriber, or network, and does not require the user or ISP to manually supply any information about himself or his network. Because the Internet appliance can identify a particular user by his IP Address, and correlate that IP Address to a unique identifier for the user/subscriber (e.g., by way of MAC Address, circuit ID, and/or digital certificate), it can maintain a database of user preferences and history that is specific for each particular computer attached to the ISP. Furthermore, the Internet appliance for controlling communication traffic does not require any information or computer code to be placed on the user's computer, either permanently or temporarily.

While not limited to any particular use, it is envisioned that only certain communication traffic will, in fact, be controlled during any one session or for any particular user. Exemplary types of traffic that can be controlled include web page preferences (i.e., delivery of certain web pages in response to certain queries or blocking of delivery of certain web pages in response to queries), and services provided in response to mistyped queries or typing of hotwords or keywords. In addition, while many configurations of the systems and methods of the present invention do not require any information to be placed on a user's computer, some advantages can be achieved by doing so. Thus, in some embodiments, the system and method comprise placing information (e.g., a cookie) on a user's system, for example to identify a specific user of the computer, to provide a specific user-centric Internet experience, etc.

Control of communication traffic is provided by the Internet appliance by monitoring information being sent by or to the user. The Internet appliance can maintain a database of user preferences, such as favorite web sites or web sites to block, and consult that database for each packet of information transmitted from or to the user. If the packet contains information relevant to the user, appropriate action can be taken to provide the user with customized information, or to eliminate certain information from the packet prior to submitting it to the Internet infrastructure.

One feature of the Internet appliance and method of controlling communication traffic according to the present invention is an option to either use or not use the Internet appliance and method to control communication traffic. This is referred to herein as an opt-in/out capability, and is implemented in preferred embodiments to provide users relying on one or more DNS implementing the Internet appliance of the invention the option to use the present methods and systems or not to use them. In essence, the Internet appliance of the invention can be thought of as a “smart wire” that can analyze information coming from a user or from the Internet infrastructure, and either use that information to execute one or more functions (thus functioning in an intelligent way), or ignore the information (thus acting as a wire). The ability to make this distinction resides within the Internet appliance, and does not require any other hardware or software on the user's PC.

Where a user has chosen to opt-in, he is provided with one or more options for customizing future communication traffic, which will then be controlled (at least until the user later elects to modify the choices or opt-out of the system) by the Internet appliance.

Once a user has opted in or out of the service, the Internet appliance can retain the election state and apply that state to all further queries originating from the computer being used. Of course, the Internet appliance is capable of applying the opt-in/out election to numerous computers within a given network, or to an entire network, if given the command from a computer with proper authority. Likewise, the services provided by the Internet appliance of the invention may be disabled (i.e., converted to an opt-out status) for certain types of queries, but not others. For example, a particular user may opt-out of allowing certain services at night, but opt-in for those same services during the day. In addition, the user, network administrator, etc. may change the opt-in/out status of the service at any time, and for any length of time (e.g., one session, one day, one week, permanently, etc.) by accessing the Internet appliance operator (e.g., the ISP or other relevant DNS operator) through its web site, telephone number, or other contact information, or by accessing a web page operated by another provider of Internet services. For example, one may opt-in or opt-out through an ISP administrator who can manually configure the Internet appliance such that it is statically configured for a particular IP Address to the desired status. In addition, an ISP administrator could create blocks of IP Addresses into which IP Addresses are assigned, one zone for those users who choose to opt-in, and one zone for those users who choose to opt-out.

In particular embodiments, the method of controlling communication traffic comprises: receiving a query generated at a point of origin; analyzing the query to determine if it contains one or more pre-defined bit strings identifying the computer at the point of origin; determining if the computer at the point of origin should be provided with personalized services; passing the query on to the Internet infrastructure if personalized services are not to be provided, or processing the query to provide personalized services if the computer at the point of origin should be provided with personalized services. In embodiments, providing the personalized services comprises directing the query to a landing page. In embodiments, providing the personalized services comprises monitoring and/or filtering of communications intended for the computer at the point of origin to provide personalized or customized information in response to the query.

In other embodiments, the method of controlling communication traffic comprises analyzing a response to a query, where the response is provided by the Internet infrastructure. Based on the response and the pre-defined preferences of the user/computer/subscriber, the method either passes the response directly to the user/computer/subscriber, or directing the response to a landing page.

Personalized services can be provided by the Internet appliance or by a second computer, referred to herein as a “subscriber server”. In embodiments, the Internet appliance detects an IP Address assignment message from the DHCP or RADIUS server, passes at least some of it (e.g., IP Address, unique identifier, lease duration information) to an internal processor or to a subscriber server that keeps track of which IP Addresses have signed up for various services. The processor or subscriber server then communicates with the Internet appliance and application server to provide specialized services. In yet other embodiments, a software module or the like can be integrated into one or more common open-source DNS servers (e.g., bind and djbdns). Software can be compiled into the DNS software applications and services provided through that mechanism. For example, when the DNS server gets an error, such as a NXDOMAIN error, or any other character string that is defined as an error, the DNS server sends traffic relating to that error to other ISP servers to analyze the error and send the requestor to a landing page.

In yet another aspect, the invention provides an Internet appliance and method for conducting business over a communications system. Accordingly, the invention provides a method of conducting business using computers. The systems and methods include maintaining a database of information relating to a particular user or network, and using that information to provide services for a fee. In embodiments, the method further comprises consulting the database for information that might be relevant to that user or network for a particular communication. For example, the database can be consulted to identify whether a particular user has joined a service plan for Internet services, whether the user prefers to avoid certain web sites when search results are returned (e.g., prefers not to receive adult web sites in response to queries), to identify prior search terms relied upon by a user, or to provide a list of web sites commonly visited by a particular user. The database can also be consulted to identify potential vendors of services of interest to the user, or for other purposes for which monetary transactions can be made. Various exemplary business purposes are described in U.S. published patent applications 2005/0105513 and 2005/0027882, and any of those are suitable business methods according to the present invention.

The above disclosure clearly indicates that the present invention encompasses a method of doing business using a computer, for example, over the Internet. The method can comprise directing communication traffic to a suitable application server, such as one that can generate a landing page comprising information that is relevant to the original query, and charging a provider of the relevant information a fee for inclusion of the information in the landing page. In embodiments, the method is a method of ad targeting using the Internet. In preferred embodiments, the method is implemented before or at the ISP level of the Internet architecture. The method of doing business using a computer includes methods in which the query comprises one or more hotwords or one or more keywords. It also includes methods in which the query comprises one or more trademarks.

One facet of the method of doing business includes the ability of an ISP to generate new clients, and thus new business. More specifically, in providing the services made available by the present invention, an ISP can attract new business and new revenue. The services enabled by the present systems, methods, and appliance permit ISP to customize their subscribers' search experiences (i.e., communication sessions) to eliminate information that is not relevant or not desired. Providing such a service can make a particular ISP more attractive to a user than another ISP. If so, the user will contract with the ISP providing the services enabled by the present invention, rather than the other ISP. In this way, an ISP implementing the present invention can generate business and revenue. Furthermore, an ISP or other organization implementing the present invention can sell advertising space on landing pages that it generates. This advertising space represents revenue that is generated by implementing the systems, methods, and appliances of the present invention.

Turning now to the figures, which depict various exemplary embodiments of the invention, it is shown that the Internet appliance is integrated into the communication pathway at the level of the ISP. While it can be integrated in any number of configurations and architectures, three common integration schemes will now be discussed: integration as an in-line appliance between the user and the ISP; integration as a parallel appliance that taps into and monitors communications between the ISP and user to correlate assigned IP Addresses with particular computers; or integration as a combined system in which ISP-resident software communicates with an external computer to transmit IP Address and computer user identity to the external computer. Each configuration has advantages, and each can be used within the invention.

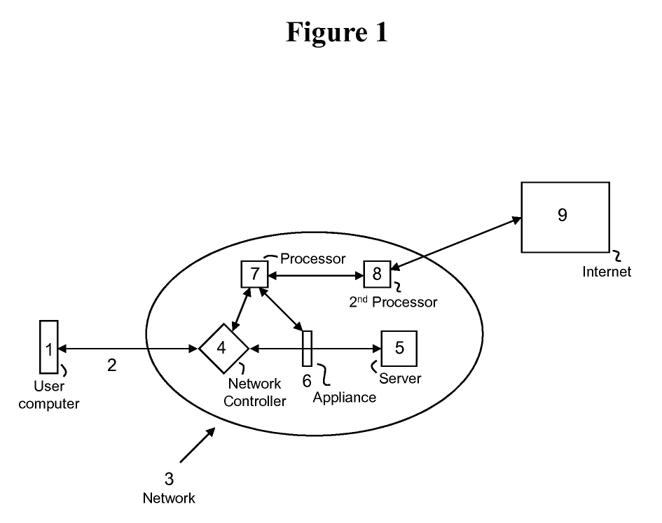

In the first exemplary configuration, the Internet appliance is integrated within the communications pathway at a point between the IP Address assignment server and the user. Such a configuration is depicted schematically in FIG. 1. All communications between the IP Address assignment server (e.g., a DHCP or RADIUS server) and the user pass through the Internet appliance of the invention, and all relevant information is monitored by the Internet appliance. In this configuration, the Internet appliance can correlate a particular user to his IP Address, and provide personalized services based on that user's pre-selected preferences, as discussed above. Where an ISP uses multiple computers to assign IP Addresses, the Internet appliance of the invention can be implemented at each computer (i.e., one Internet appliance per IP Address assignment server) or two or more IP Address assignment servers can be linked to a single Internet appliance.

In this embodiment, the user 1 is connected to the network 3 by way of linkage or communication pathway 2. The linkage or communication pathway can be any suitable linkage, including, but not limited to, cable, telephone wiring, electrical wiring, and signals within the electromagnetic radiation scale, such as radio signals, light signals, and microwave signals. The network can be any type of network for communication, including, but not necessarily limited to, a computer network (such as an ISP network) and a telephone network. As information enters the network 3, it is typically accepted by a network controller, such as a router or network access server 4. The access server passes information to an IP Address assignment server 5 in order to provide the user 1 with an IP Address for the communication session. Interposed between the access server 4 and the IP Address assignment server 5 is the Internet appliance of the invention 6, which receives information from the user, passes the information to the IP Address assignment server 5, receives back from the IP Assignment server 5 information correlating the newly assigned IP Address and one or more unique identifiers of the user, such as MAC address, etc. In essence, the Internet appliance 6 is monitoring the communication between the user 1 and the IP Address assignment server 5, looking for the IP Address assignment server's acknowledgment message to the user 1 confirming the user's IP Address for the session. Information correlating the IP Address and at least one unique identifier for the user/subscriber is passed to a processor 7 that can maintain a table correlating the IP Address with the particular user/subscriber, and a database of pre-defined preferences for that particular user/subscriber. Based on these pre-defined preferences, the processor 7 will monitor information passing between the user 1 and the Internet 9, and, if the user 1 has chosen to receive one or more services, the processor 7 will control communication between the user 1 and the Internet 9. In certain embodiments, the processor 7 is a PLE device disclosed in co-pending U.S. application Ser. No. 11/019,369. Where applicable, the processor 7 passes information to a second processor 8 prior to the information being transmitted to the Internet 9. Preferably, the only information passed will be information generated by the user. That is, preferably, no information regarding the identity of the user or correlation of that identity with a particular IP Address will be passed from the processor 7 to the second processor 8. The second processor 8 is typically an ISP caching DNS or a similar processor. In embodiments where the communications network comprises a telephone network, the telephone network may be interposed between the user 1 and the IP network 3, and may provide any number of services to the user as part of the communications system.

FIG. 1 depicts an embodiment in which all of the functions of the system are provided within the network. Of course, in other embodiments, some or all of the functions may be provided outside of the network, per se. Thus, in embodiments, one or more piece of hardware that is used to provide one or more function depicted in FIG. 1 is physically located in a place different than one or more other piece of hardware. Likewise, in embodiments, certain hardware or software can be controlled by an entity other than the network provider. For example, while the processor 7 may be used as an integral part of the communication system of the network, it may be owned and controlled by a party other than the network, and merely provide services to the network on a contract basis. Furthermore, as discussed above, communications between the Internet appliance 6 and the processor 7 can be via an interrupt or polling process. In addition, it is to be noted that, for the sake of clarity, the figures depict only one device or functional unit of the system. However, it should be understood that each system of the invention can have one or more of each device or functional unit deployed, in any combinations, to achieve desired results (e.g., computing power, back-up systems, load balancing, etc.).

Furthermore, processor 7 may be configured to function such that it can participate in communications with the Internet 9 without routing traffic through processor 8 (configuration not shown in the Figure). In this way, processor 7 may receive information from user 1, processor 8, or the Internet 9 directly and provide connections or options for connections to the Internet 9 based on any number of pre-defined criteria. For example, when processor 7 receives information that the user has elected not to receive, processor 7 can redirect the user to a landing page that contains different information than that which would have been delivered to the user from the Internet. Processors 7 and 8 can be combined into a single processor, either physically or functionally, or may be provided as independent hardware and/or software. In addition, processor 7 (whether in this embodiment or others) may be configured to communicate with multiple different processors 8, as may be the situation where an ISP provides multiple caching DNS that processor 7 may access and communicate with.

To improve the performance of the system, and to ensure that failures in the Internet appliance 6 do not interrupt communications between the user 1 and the Internet 9, the Internet appliance 6 can be configured to have a fail-safe switch that re-routes communication traffic from the monitoring function to a simple connection (be it a hard wire connection or any other suitable means for passing information from one point to another). Re-routing of communication traffic to the simple connection can be performed automatically when the Internet appliance 6 detects a failure in its monitoring and/or traffic control functions.

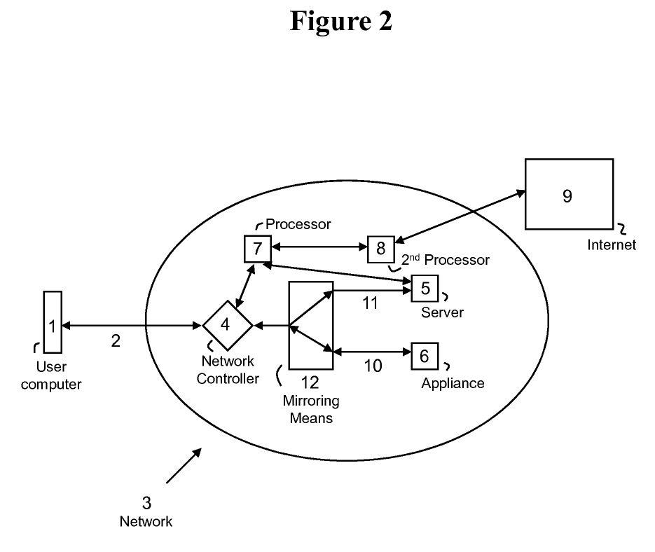

The second exemplary configuration of implementation of the Internet appliance of the present invention is as a “tap” into the communication line between the user and the ISP. This exemplary configuration is depicted schematically in FIG. 2. In this configuration, the Internet appliance of the invention passively monitors all the traffic to and from the ISP's IP Address assignment servers. One advantage of this configuration is that failures in the Internet appliance do not cause any alteration in the communication traffic between the user and the Internet because no information that is necessary for connection to the Internet is passed through the Internet appliance.

As can be seen in FIG. 2, the user 1 is connected to the network 3 by a connection 2, just as in FIG. 1. However, at the network level, interposition of the appliance 6 between the user 1 and the IP Address assignment server 5 does not occur as in the embodiment described with regard to FIG. 1. Rather, the Internet appliance 6 is provided in a separate communication pathway 10, which is parallel to the communication pathway 11 between the user 1 and the IP Address assignment server 5. In this configuration, information between the user 1 and the IP Address assignment server 5 is mirrored from pathway 11 to pathway 10, and the Internet appliance 6 receives all of the information necessary to correlate a particular IP Address with a user/subscriber. Upon receipt of this information, the Internet appliance 6 communicates with a processor 7, which may contain tables and/or databases that indicate the user's preferences for one or more communication services. Based on these pre-defined preferences, the processor 7 will monitor information passing between the user 1 and the Internet 9, and, if the user 1 has chosen to receive services, the processor 7 will control communication between the user 1 and the Internet 9. In certain embodiments, the processor 7 is a PLE device disclosed in co-pending U.S. application Ser. No. 11/019,369. Where applicable, the processor 7 passes information to a second processor 8 prior to the information being transmitted to the Internet 9. The second processor 8 is typically an ISP caching DNS or a similar processor. The mirroring function can be provided by any suitable means 12, including a switch. As with the embodiments depicted in FIG. 1, the processor 7 may be configured to communicate directly with the Internet and provide various services based on pre-defined preferences. Furthermore, like the embodiment of FIG. 1, processors 7 and 8 can be combined into a single processor, either physically or functionally.

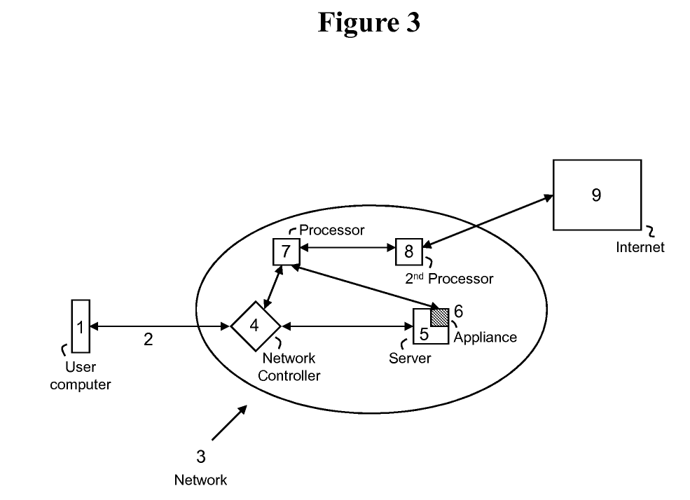

In a third exemplary embodiment, the Internet appliance is configured to comprise computer code resident on one or more ISP servers. This computer code provides the monitoring function, and communicates the information to another computer, which is part of the Internet appliance system. This exemplary configuration is depicted in FIG. 3.

More specifically, as in FIGS. 1 and 2, user 1 connects to a network 3 by way of a communication line 2. Information is processed by a network-operated controller 4 (e.g., a router) and sent to an IP Address assignment server 5. In the embodiment depicted in FIG. 3, the IP Address assignment server 5 comprises the Internet appliance of the invention 6. The Internet appliance 6 is preferably included as software that runs on the IP Address server 5, but may comprise hardware (e.g., a circuit board) as well. The Internet appliance 6 monitors communications between the IP Address assignment server 5 and the user 1 to correlate IP Address and a unique identifier for the user 1. That information is passed from the Internet appliance 6 to a processor 7, which provides the functions discussed above. As with the other exemplary configurations, processor 7 may be connected to processor 8 and then to the Internet 9, or may be connected directly to the Internet 9.

The Internet appliance 6 can monitor communications at various points along the various communication pathways. For example, it can monitor communications at the point of assignment of IP Address, at the point of sending information to the user 1, or at the point of storing the correlation data for each user and assigned IP Address.

While FIG. 3 depicts the Internet appliance 6 as a component and/or function provided by the IP Address assignment server 5, it should be evident that the reverse configuration may be provided as well, the difference merely being a matter of semantics. That is, while FIG. 3 depicts the IP Address assignment server 5 comprising the Internet appliance 5, it can be equally understood that the Internet appliance 5 comprises the IP Address assignment server 6, as a physical component, a functional component, or both. Likewise, with regard to all three of FIGS. 1-3, any one or more component, whether the component be a physical or functional component, may be provided within the network framework (i.e., within the physical confines of the network premises or under the control of the network provider) or as an external component or service, which is provided as an integrated portion of the network or as an external service provided to the network by a third party. Integration into the network in either scenario is preferably accomplished seamlessly to provide the user a uniform and smooth communication session.

While all three of the exemplary embodiments described above provide the monitoring functions of the invention, the third is quite simple and effective. However, it also requires each ISP to modify the programming running the IP Address assignment server, which can be a complex and time-consuming activity. In contrast, the first and second exemplary embodiments are equally effective, but require the implementation of additional hardware into the communication system at the ISP level. Thus, each exemplary configuration has advantages, which might be preferable to particular users of the invention.

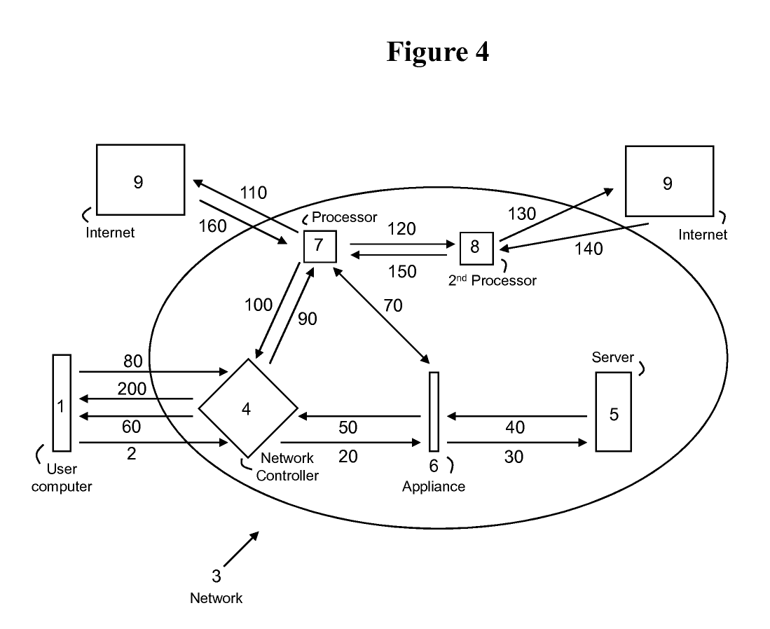

FIG. 4 depicts various pathways for communications traveling between a user 1 and the Internet 9 in systems where the Internet appliance of the present invention is used. To facilitate understanding, only the embodiment depicted in FIG. 1 is considered in FIG. 4. It is to be understood that the general scheme of information flow discussed with regard to FIG. 4 can be applied to all three exemplary embodiments discussed above. Other information flow schemes will be apparent to those of skill in the art based on common schemes of information flow.

In FIG. 4, a user, whether he be a user of the Internet for information purposes or a user of a telephone system that relies, at least in part, on the Internet, logs on to a network in order to get access to the Internet. A communication line 2 is established between the user 1 and the network 3. A controller 4, such as a router, at the network 3 routes the communication from the user 1 to an IP Address assignment server 5 via communication line 20. Communication over line 20 is received by the Internet appliance 6, processed, and passed on to the IP Address assignment server 5 via communication line 30. IP Address assignment server 5 assigns the user 1 an IP Address and sends the IP Address to user 1 over communication line 40. The Internet appliance 6 receives the communication containing the assigned IP Address and unique identifier(s) for user 1 from the IP Address assignment server 5, processes the information to at least correlate the IP Address with the unique identifier(s), and passes the information to the user 1 via communication line 50. Router 4 receives the information and passes it to user 1 via communication line 60. Information regarding the correlation between the user's unique identifying information and his assigned IP Address is communicated via communication line 70 from the Internet appliance 6 to a processor 7 or processor 7 can poll Internet appliance 6 at periodic intervals for the same information, which typically contains one or more databases relating to preferences selected by the user during one or more previous communication sessions. Upon receipt of his IP Address, user 1 requests information from the Internet over communication line 80. If the user or application uses a hostname/domain name, data is sent to controller 4, which routes the information request to processor 8, which is typically a caching DNS operated by the network (e.g., the ISP to which the user subscribes) over communication line 90. Processor 7 is interposed between controller 4 and processor 8, and intercepts the communication passing along communication line 90. Processor 7 screens the IP Address associated with the DNS look-up request from user 1, compares the IP Address with the correlation between IP Address and unique identifier, which was supplied by Internet appliance 6, and determines the identity of user 1 (based on the unique identifier(s) for that user). Processor 7 consults a table or database regarding the particular user to determine if personalized or customized services should be provided. If such services are to be provided on exiting communications (e.g., return of a particular IP Address (e.g., web site) based on submission of a keyword or hotword), processor 7 provides those services at this time and returns a communication to the user 1 over communication line 100 via controller 4 and communication line 200; sends a communication requesting customized information from the Internet 9 directly to the Internet 9 over communication line 110; or sends a communication request to the Internet 9 via processor 8 over communication line 120. If, on the other hand, such services are to be provided on communications returning from the Internet 9, processor 7 passes the request to the Internet 9 either directly over communication line 110 or by way of processor 8 and communication lines 120 and 130. Information returned from the Internet 9 via communication lines 140 and 150 or via communication line 160 is then processed by processor 7 based on the pre-defined preferences of the user 1. Modified information from processor 7 is communicated to user 1 over communication lines 100 and 200.

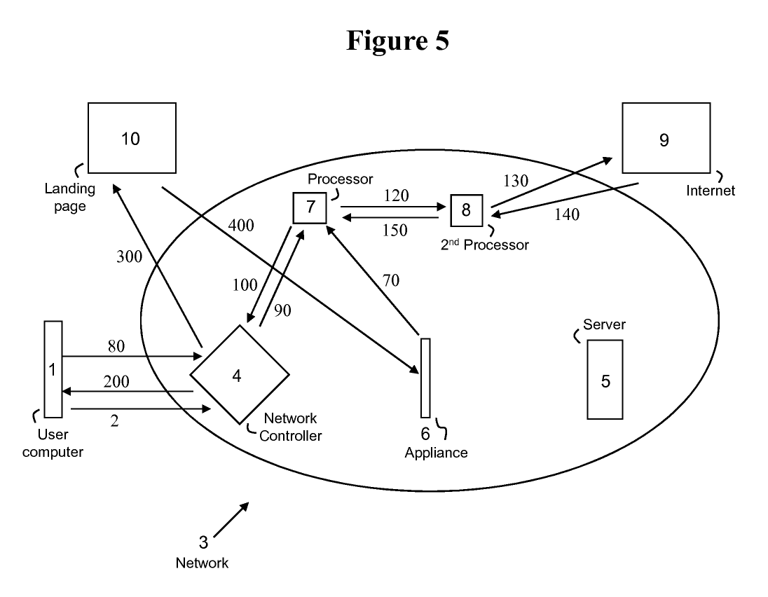

FIG. 5 depicts another configuration of the system of the present invention, and shows communication pathways during a typical communication session in which a malformed or otherwise unresolvable query (e.g., mis-typed IP Address look-up) is submitted to the Internet infrastructure, and the user is provided with the option to participate in a service provided by his ISP. In this embodiment, the user is one that has a static IP Address, and thus does not require an IP Address assignment from IP Address assignment server 5.

More specifically, in the embodiment depicted in FIG. 5, an Internet appliance 6 of the present invention is used in conjunction with an Internet appliance 7 according to U.S. patent application Ser. No. 11/019,369, which is referred to herein as a “Paxfire PLE”. In this embodiment, user 1 sends a DNS query to router 4 via communication pathway 2. Router 4 forwards the query to PLE 7 via communication pathway 90. PLE 7 forwards the query to DNS server 8 via communication pathway 120, at which point DNS server 8 talks to other authoritative DNS servers in the Internet 9 via communication pathways 130 and 140. An authoritative server within the Internet 9 responds via communication pathway 140 with an error message, indicating that the requested IP Address does not exist. DNS server 8 forwards the error message to user 1 thru the PLE 7 and communication pathways 150 and 100. In passing through PLE 7, the error message is modified by the PLE 7 to redirect or point the user 1 to web server 10, and this redirect message is sent to router 4 via communication pathway 100. Router 4 forwards the redirect address to user 1 via communication pathway 200. Upon receipt of the redirect IP Address, the user 1, through the function of his browser application, sends web traffic to router 4 via communication pathway 80. Because of the redirect IP Address supplied by PLE 7, this web traffic is destined for web server 10 by way of communication pathway 300. A landing page provided by web server 10 provides the user with the option to opt-out of one or more services provided by the ISP. If user 1 elects to opt-out of one or more services provided by the ISP, the web server 10 sends a notification of opt-out to Internet appliance 6 via communication pathway 400. Internet appliance 6 then notifies PLE 7 via communication pathway 70 that the IP Address assigned to user 1 has opted-out of particular services. Because PLE 7 has not received (in the case of interrupt service provided by Internet appliance 6) or found (in the case of polling service provided by Internet appliance 6) information regarding the IP Address of user 1, it concludes that the IP Address associated with user 1 is likely static. PLE 7 can store this information for use in later communication sessions or, more preferably, can supply this information to Internet appliance 6 for storage in its database. In this and future communication sessions, because user 1 has opted out of services, PLE 7 will not modify communication traffic going to and, more preferably, returning from the Internet 9.

In preferred embodiments, future communication sessions involving that particular IP Address would apply the opt-out status (i.e. a pre-defined user preference) and provide the user with a customized communication session. Of course, if user 1 were to have elected to opt-in (or had chosen not to opt-out) of any or all services provided by the ISP, that status would also have been retained by the system, and preferably Internet appliance 6, for use in future communication sessions.

It should be recognized that the same general scenario depicted in FIG. 5 would be applicable if the user were to have a dynamically assigned IP Address. However, in that situation, Internet appliance 6 would monitor assignment of IP Address to the user, determine the opt-in/opt-out status of the user, and supply the opt-in/opt-out status to PLE 7 so that the proper services could be provided to the user.

As discussed above, numerous configurations of the system can be implemented by users. For example, processors 7 and 8 can be combined into a single physical and/or functional unit; Internet appliance 6 and IP Address assignment server 5 can be merged into a single physical and/or functional unit; all of processors 7 and 8, appliance 6, and server 5 can be merged into a single physical and/or functional unit; or two or more other functions and/or physical components can be combined into a single unit. Where two or more physical or functional units are combined, the number of physical parts of the system may be reduced, thus providing a cost savings in implementing the systems. Furthermore, because each physical and functional unit can be linked via communication lines (either physical or electromagnetic), there is no need for all parts, or any particular combination of parts, of the system to be in close physical proximity. Those implementing the systems of the present invention may configure the systems in any suitable fashion to achieve a particular goal.

The systems and methods of the present invention are implemented by way of computers and computer programs. The systems comprise one or more computers comprising integrated circuits for processing of information. The systems and methods can be, but are not necessarily, implemented without the need to install any new hardware or software into ISP networks, and thus are modular, highly adaptable, and easy and cost-effective to implement. In addition, because the Internet appliance of the invention can be provided partially or entirely as software, it can be implemented and maintained (e.g., updated) rapidly, easily, and inexpensively.

Electronic components and connections used in the Internet appliance of the invention are those typically used in the computer industry, as are all other structural elements of the systems. In preferred embodiments, the Internet appliance of the invention is implemented with one or more ISP servers. In these embodiments, the various pieces of hardware, software, and functional units of the Internet appliance can reside on many types of ISP servers, on separate hardware from the ISP servers, or partially on the ISP servers and partially on separate hardware. In certain embodiments, the Internet appliance is provided entirely on separate hardware from the ISP servers. The Internet appliance of the invention and the ISP servers can be physically connected via cables, wires, or the like. The connection can be direct (i.e., from one to the other without any intervening hardware, except via the connector) or indirect (i.e., through one or more other hardware devices, such as circuit boards, filters, etc.). In other embodiments, the connection is not a physical connection (e.g., it is a connection via electromagnetic energy, such as infrared signals, radio signals, microwave signals, optical signals, and the like). In certain embodiments, the Internet appliance is implemented directly within the ISP DNS server (e.g., by insertion of a circuit board into the server). In other embodiments, certain functionalities are implemented directly within the ISP server(s), while other functionalities are implemented one or more other physical components, which are connected, either physically or non-physically.

One advantageous aspect of certain architectural configurations of the present Internet appliance derives from the fact that the Internet appliance is a general purpose software engine. As such, it can run software modules other than those of the present invention to deliver other services at this infrastructure layer. In addition, it is to be noted that the Internet appliance is not limited in the number of pieces or location of hardware that are depicted and discussed in exemplary embodiments, and that other hardware and software may be included in different embodiments, such hardware and software being implemented for various functions typically performed by computers and Internet trafficking servers.

It is important to note that, as discussed above, the Internet appliance, while being implemented through hardware and software, is made up of functional elements. Thus, each functional unit may exist on a single or multiple different pieces of hardware. Furthermore, each functional unit may be resident on a single or multiple different pieces of hardware, located in the same geographical area or in widely dispersed geographical areas. It is well within the skill of those of skill in the art to implement different functions on different pieces of hardware, which are either directly connected or connected through one or more intervening pieces of hardware. Likewise, although software to control different functionalities that are located on different pieces of hardware, or that exist as multiple copies within the system is part of the present invention, other software that can be implemented to further control certain aspects of the methods and systems, which can be implemented by the operator of the invention based on various desires, can be integrated into the present invention without undue or excessive experimentation by one of skill in the art.

Thus, in embodiments, the Internet appliance of the invention, whether it be used for monitoring communication traffic, controlling communication traffic, or both, comprises at least one processor that receives communication information from a user, analyzes the information for the user's identity, receives communication information from a server that assigns IP Addresses, and analyzes the information to correlate the IP Address with the user's computer's identity. The processor can further direct additional communications to and from the user and the Internet to selected IP Addresses based on pre-defined conditions. Analyzing can be any manipulation of data that requires recognition of one or more bit sequences. Thus, analyzing can include converting a human language request into an IP Address request and determining whether the IP Address is resolvable, determining the IP Address of the user, determining the MAC Address of the user, identifying a bit string, and the like. As discussed above, pre-defined conditions can be any number of things, including IP Address of the request, IP Address or MAC Address of the user, bit strings that have been defined as impermissible, the format of the query (e.g., hotword, keyword, HTTP, SMTP, etc.), or the like.

In embodiments, the Internet appliance comprises at least one processor that receives a query from a user; passes the query on to the Internet infrastructure, receives information from the Internet infrastructure; analyzes the information received from the Internet infrastructure; and directs the query to a first landing page if certain pre-defined conditions are met, or passes on the information from the Internet to the user or directs the query to a second landing page if those conditions are not met. Analyzing can include any or all of the functions discussed herein. In certain embodiments, the processor(s) of the appliance analyzes information received from the query and/or synthesizes information received from the query and the Internet. Thus, in embodiments, one or more processor collects and retains information upon receipt of query, collects and retains information upon receipt from Internet infrastructure, or both. The pre-defined conditions can be any of those discussed herein, including but not limited to the opt-in or opt-out status of the user.

As mentioned above, the functions discussed above can be provided on a single processor or two or more processors, the functions being distributed among the processors in accordance with the designs of the operator of the appliance. As used herein, a processor is any hardware, software, or combination of two or more of either or both that can process information within the framework of a computer system. Examples of processors include, but are not necessarily limited to, central processing units (CPU), circuit boards, chips, software, and the like. Where multiple processors are used, they can be connected in serial or parallel. That is, the multiple processors can perform their assigned functions, whether it be a function provided solely by the processor or a function that is redundant to or shared by other processors, at the same time other processors are performing their assigned functions, or one or more processor can act only after one or more other processor has completed its function.

In view of the disclosure above, in a particular embodiment, the Internet appliance comprises: a processor that receives information from a user regarding the identity of that user (i.e., a unique identifier); a processor that receives information from a server that assigns IP Addresses regarding the IP Address to be assigned to the user; and a processor that analyzes the information from the user and the server. Analyzing can comprise correlating the IP Address and unique identifier. Analyzing can comprise determining if the user associated with the unique identifier has elected to receive one or more services (i.e., opted-in to a service). The Internet appliance can further comprise a processor that submits a query from the user to the Internet infrastructure. It can further comprise a processor that returns communication traffic to the user from the Internet. In embodiments, it comprises a processor that directs the query, the return communication traffic, or both, to a landing page if the user has opted-in to one or more services. In embodiments, two or more of these functions are provided by a single processor. In embodiments, a single processor provides all of the functions.

As is evident from the above disclosure, multiple pieces of hardware and combinations of hardware and software can be used to implement the Internet appliance of the present invention. Thus, in embodiments, the Internet appliance can comprise means for receiving a unique identifier of a user; means for receiving information regarding assignment of an IP Address to that user; and means for correlating the unique identifier and the IP Address. It can further comprise means for maintaining information regarding the unique identifier in a table or database. It can further comprise means for transmitting communication information from the user to the Internet. It furthermore can comprise means for controlling communication traffic between the user and the Internet. Such controlling means can comprise consulting a table or database of user preferences and modifying the communication to or from the user or Internet to comport with those preferences. In embodiments, the Internet appliance can comprise means for directing communication traffic to an IP Address containing personalized information relevant to the user.

As can be envisioned from the disclosure above, the systems and methods of the invention can be provided as part of an ISP service package. Thus, the Internet appliance of the present invention can function as an ISP DNS, which can include one or more other functions provided by the ISP, such as DHCP or RADIUS functions. It should thus also be evident from the above discussion that the Internet appliance of the present invention can be used as part of an ISP server. In addition, it should be evident that the Internet appliance can be used as, or as part of, a DNS server within the Internet architecture. Thus, it can be used as a caching/recursive DNS or as an authoritative DNS within the Internet architecture.

Furthermore, it should be evident that the present invention comprises computers, hard drives, memory chips, memory sticks, CDs, DVDs, tapes, and other devices and articles of manufacture that can be used to store computer programs to perform the various functions of the system and methods of the present invention. Those of skill in the art are well aware of the numerous types of hardware and the numerous types of software code, and combinations of the two, that can effect the functions described herein. Accordingly, they need not be detailed here.

In embodiments, the invention comprises an article of manufacture for use as a computer program transmission apparatus. The article of manufacture comprises: at least one device comprising a substrate capable of storing electronic information that enables a computer to perform at least one function (e.g., a computer disk, removable or stationary), wherein the function comprises a process for dynamically monitoring communication traffic between a computer at a point of origin and a server that issues device identifiers, and wherein the process comprises: receiving a unique identifier from a computer at a point of origin; receiving a device identifier that has been issued by a computer server that issues device identifiers; correlating the unique identifier and the device identifier; and dynamically using the correlation information to control communication traffic. In some embodiments, the article of manufacture is a program storage device readable by machine, tangibly embodying a program of instructions executable by the machine to dynamically monitor communication traffic between a computer at a point of origin and a server that issues device identifiers. The article of manufacture can, in some embodiments, comprise at least one computer hard drive or at least one random access memory chip.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For example, the principles of the invention in their broader aspects may be applied to other network systems such as for telephony. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A system for monitoring and/or controlling communication traffic between a user computer and the Internet, the system comprising:
an Internet Appliance having opt-in and opt-out capabilities, such that
when an opt-in capability is selected, the Internet Appliance is configured to:
receive one or more unique identifiers for a user computer,
receive information regarding an address assigned to the user computer by a computer that assigns the address in response to a request containing the unique identifier(s), and
correlate the unique identifier(s) and the assigned address; and
when an opt-out capability is selected, the Internet Appliance is configured to:
permit communication traffic between the user computer and the Internet to flow without providing any communication services; and
a processor that controls communication traffic between the user computer and the Internet based at least in part on the correlated information when the opt-in capability is selected, but not when the opt-out capability is selected,
wherein the Internet Appliance, the processor, or both comprise hardware.

2. The system of claim 1, wherein the Internet Appliance ignores information about the user computer when the opt-out capability is selected.

3. The system of claim 2, wherein the opt-out capability is selected according to variable settings.

4. The system of claim 1, wherein the Internet Appliance and/or processor consults a table or database of user information and causes communication from the user computer to the Internet, or vice versa, to be modified based on one or more pieces of user information.

5. The system of claim 4, wherein the user information includes information obtained from one or more packets sent to or from the user computer.

6. The system of claim 5, wherein the information obtained from one or more packets corresponds to one or more: websites, source IP addresses, destination IP addresses, search terms, hotwords, keywords, geographic locations, or phone numbers.

7. The system of claim 4, wherein the user information corresponds to user preferences.

8. The system of claim 1, wherein the processor directs communication traffic to a landing page containing personalized information relevant to the user.

9. The system of claim 1, wherein the processor provides personalized services to the user based at least in part on the correlated information.

10. The system of claim 1, wherein the system does not place information, or cause information to be placed, on a storage device or medium of the user computer.

11. The system of claim 1, wherein the Internet Appliance is inter-disposed between the user computer and a server that assigns an address to the user computer.

12. The system of claim 1, wherein the processor and Internet Appliance are the same device.

13. The system of claim 1, wherein the processor and Internet Appliance are separate devices.

14. The system of claim 1, wherein the unique identifier(s) correspond to one or more of: a MAC Address, a circuit ID, a digital certificate, or a cookie.

15. A method for monitoring and/or controlling communication traffic between a user computer and the Internet, the method comprising:
providing the user the option of having communications analyzed and communication services provided,
wherein if the user chooses to have communications analyzed and communication services provided,
receiving one or more unique identifiers for a user computer;
receiving information regarding an address assigned to the user computer by a computer that assigns the address in response to a request containing the unique identifier(s);
correlating the unique identifier(s) and the assigned address; and
wherein if the user chooses not to have communication services provided, allowing communications to flow between the user and the Internet without providing such services; and
controlling communication traffic between the user computer and the Internet based at least in part on the correlated information when the user chooses to have communications analyzed, but not when the user chooses not to have communications analyzed.

16. The method of claim 15, wherein the method comprises ignoring information about the user computer when the user has selected not to have communications analyzed.

17. The method of claim 16, wherein the option of having communications analyzed includes variable settings to allow for some, but not all, communications to be analyzed.

18. The method of claim 15, further including consulting a table or database of user information and causing communication from the user to the Internet, or vice versa, to be modified based on one or more pieces of user information.

19. The method of claim 18, further including obtaining information about a user from one or more packets sent to or from the user computer.

20. The method of claim 19, wherein the information obtained from one or more packets corresponds to one or more: websites, source IP addresses, destination IP addresses, search terms, hotwords, keywords, geographic locations, or phone numbers.

21. The method of claim 18, wherein the user information corresponds to user preferences.

22. The method of claim 15, further including directing communication traffic to a landing page containing personalized information relevant to the user.

23. The method of claim 15, further including providing personalized services to the user based at least in part on the correlated information.

24. The method of claim 15, wherein the unique identifier(s) correspond to one or more of: a MAC Address, a circuit ID, a digital certificate, or a cookie.
